(19) United States
(12) Patent Application Publication
(10) Pub. No.: US 2024/0142340 A1
(43) Pub. Date: May 2, 2024

(54) Optical Module, Alignment System and Optical Monitoring Method

(71) Applicant: Nippon Telegraph and Telephone Corporation, Tokyo (JP)

(72) Inventors: Yuji Fujiwara, Musashino-shi, Tokyo (JP); Kei Watanabe, Musashino-shi, Tokyo (JP)

(21) Appl. No.: 18/548,288

(22) PCT Filed: Apr. 7, 2021
(86) PCT No.: PCT/JP2021/014832

§ 371 Date: Aug. 29, 2023

(51) Int. Cl. G01M 11/00; G02B 6/26; G02B 6/36

(52) U.S. Cl. CPC G01M 11/33; G02B 6/262; G02B 6/3616

(57) ABSTRACT

Provided is an optical module that accurately observes the overall intensity of visible light having a relatively short wavelength and propagating through an optical fiber, and is suitable for downsizing an optical device. An optical module provided in an optical fiber connected to an optical component capable of inputting or outputting light. The optical module includes: a case body that forms a closed space C in which a part of the optical fiber is accommodated; a fiber fixing portion that fixes the optical fiber to predetermined position and shape inside the case body; and a photodiode that is attached inside the case body at a position capable of receiving radiation light radiated from the optical fiber fixed to the fiber fixing portion.

### TECHNICAL FIELD

The present invention relates to an optical module using an optical fiber, an alignment system of the optical module, and an optical measurement method of an optical fiber.

### BACKGROUND ART

Small optical modules including a plurality of optical components combined have been developed. Such an optical module is disclosed in, for example, Non Patent Literature 1, and the 3D measurement system disclosed in Non Patent Literature 1 is configured by connecting a laser light source and a planar light wave circuit (hereinafter, referred to as “PLC”) via an optical fiber. The 3D measurement system disclosed in Non Patent Literature 1 is described such that a laser beam emitted from a laser light source is divided into two equal light beams by a 3 dB fiber coupler, and the divided light beams interfere with each other to project a fringe pattern on an object. In addition, Non Patent Literature 2 discloses development of a small RGB fiber coupler with a small amount of loss for each color. Such an optical module can achieve a small optical device in which the number of alignment steps is small and the optical axis is hardly shifted due to vibration as compared with an optical system including a bulk component.

In addition, in order to continuously and stably operate the 3D measurement system as described above, it is necessary to monitor the intensity of light propagating through the PLC of the optical module and the optical fiber, and perform maintenance such as axial alignment (alignment) or replacement of the optical fiber as necessary. Known maintenance of the optical system using an optical module is performed by calculating the overall light intensity propagating through the optical fiber using the intensity of the light divided by the fiber coupler as described above.

### CITATION LIST

### Non Patent Literature

Non Patent Literature 1: S. Katayose et al, “Fabrication and demonstration of ultra-compact 3D measurement module using silica-based planar lightwave circuit”, Jpn. J. Appl. Phys., Vol. 59, No. SOOD01, 2020.

Non Patent Literature 2: Sakamoto, et al., “Compact and low-loss RGB coupler using mode-conversion waveguides”, Opt. Commun., Vol. 420, pp. 46-51, 2018.

### SUMMARY OF INVENTION

### Technical Problem

However, it is known that a commercially available fiber coupler cannot obtain sufficient reliability for visible light having a relatively short wavelength. Such a feature is considered to be caused by the fact that the optical fiber of the fiber coupler causes fluctuation in transmittance and refractive index called photodarkening with respect to light having a particularly short wavelength among visible light. Such a tendency is remarkable for visible light having a wavelength of 500 nm or less and a light intensity of about several tens of mW, and when visible light having a short wavelength is input to the fiber coupler, the branching ratio to the optical fiber varies over time.

In order to avoid the above point, it is conceivable to use a bulk component such as a beam splitter instead of the fiber coupler. However, when the beam splitter is used, the size of the optical device including the optical module is increased, and application of the optical device is considered to be limited. In addition, the beam splitter causes a connection loss of light when the light is recombined to the optical fiber at the subsequent stage of the beam splitter. The connection loss is an error in calculating the overall light intensity propagating through the optical fiber from the light split by the beam splitter.

The present invention has been made in view of the above points, and relates to: an observation module, which is an optical module that accurately observes the overall intensity of visible light having a relatively short wavelength and propagating through an optical fiber, and is suitable for downsizing an optical device; an alignment system; and an optical measurement method.

### Solution to Problem

An optical module according to an aspect of the present invention is an optical module provided in an optical fiber connected to an optical component capable of inputting or outputting light, the optical module including: a case body that forms a closed space in which a part of the optical fiber is accommodated; a fiber fixing portion that fixes the optical fiber to predetermined position and shape inside the case body; and a light receiving element that is attached inside the case body at a position capable of receiving radiation light radiated from the optical fiber fixed to the fiber fixing portion.

An alignment system according to an aspect of the present invention is an alignment system that aligns an optical fiber connected to an optical component capable of inputting or outputting light, the alignment system including: an optical module including a case body that forms a closed space in which a part of the optical fiber is accommodated, a fiber fixing portion that fixes the optical fiber to predetermined position and shape inside the case body, and a light receiving element that is attached inside the case body at a position capable of receiving radiation light radiated from the optical fiber fixed to the fiber fixing portion; a light source that causes light to be incident on at least a portion accommodated inside the case body of the optical fiber from one end portion of the optical fiber; and an alignment mechanism that adjusts a position of at least one of the light source and the end portion on the basis of the radiation light received by the light receiving element.

An optical measurement method according to an aspect of the present invention is an optical measurement method used for observing light propagating through an optical fiber connected to an optical component capable of inputting or outputting light, the optical measurement method including: a step of receiving radiation light radiated from an optical fiber fixed to predetermined position and shape inside a case body forming a closed space; and a step of determining intensity of the light propagating through the optical fiber on the basis of intensity of the radiation light that has been received.

### Advantageous Effects of Invention

According to the aspects described above, it is possible to provide: an optical module that accurately observes the overall intensity of visible light having a relatively short wavelength and propagating through an optical fiber, and is suitable for downsizing an optical device; an alignment system; and an optical measurement method.

### BRIEF DESCRIPTION OF DRAWINGS

FIG. 1 is a schematic diagram for explaining an experiment showing the basis of the present invention.

FIG. 2(a) is a diagram illustrating a relationship between propagation light and radiation light obtained by the experiment described with reference to FIG. 1, and FIG. 2(b) is a diagram illustrating a temporal change in a difference between the propagation light and the radiation light.

FIG. 3 is a perspective view illustrating an appearance of an optical module of a first embodiment.

FIG. 4 is a longitudinal sectional view of the optical module illustrated in FIG. 3.

FIG. 5 is a schematic top view of the optical module illustrated in FIGS. 3 and 4 as viewed from above.

FIG. 6(a) is a cross-sectional view taken along a cross-sectional line VIa illustrated in FIG. 5, FIG. 6(b) is a cross-sectional view taken along a cross-sectional line VIb, FIG. 6(c) is a cross-sectional view taken along a cross-sectional line VIc, and FIG. 6(d) is a view illustrating a positional relationship between the cross section illustrated in FIG. 6 (c) and an optical fiber and a photodiode.

FIG. 7 is a schematic diagram for explaining an alignment system of the first embodiment of the present invention.

FIG. 8 is a diagram for explaining an overview of a second embodiment of the present invention.

FIG. 9 is a schematic top view of the optical module described in FIG. 8 as viewed from above.

### DESCRIPTION OF EMBODIMENTS

### Overview

Prior to describing an embodiment of the present invention, an overview of the present invention will be described below.

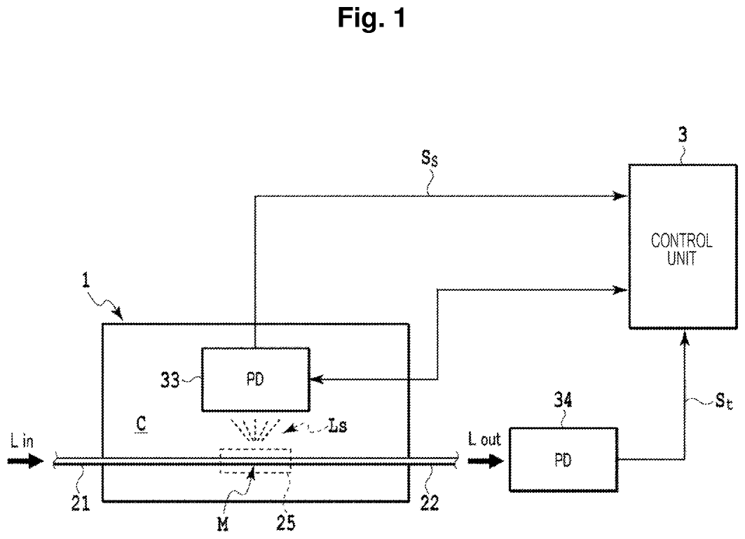

FIG. 1 is a schematic diagram for explaining an experiment showing the basis of the present invention. The configuration illustrated in FIG. 1 includes an optical module 1 including a closed space C having a photodiode (indicated as “PD” in the drawing) 33 therein, optical fibers 21, 22 inserted into the closed space C, and a control unit 3 that inputs a radiation signal Ss indicating received light intensity of light received by the photodiode 33 and a propagation signal St indicating received light intensity of light received by the photodiode 34.

The optical fiber 21 and the optical fiber 22 are connected in the closed space C. In the experiment, the optical fibers 21 and 22 were thermally fused and connected by arc discharge. A fused portion of the optical fibers 21 and 22 is illustrated in FIG. 1 as a fused portion M. Light is incident from a light source (not illustrated) toward the optical fiber 22 from the optical fiber 21 among the optical fibers 21, 22 that have been fused to each other. In the experiment, a laser device was used as a light source, and laser light was incident on the optical fibers 21, 22. The laser light incident on the optical fiber 21 is referred to as incident light Lin, and the laser light emitted from the optical fiber 22 is referred to as emission light Lout. The wavelength of the laser light is 405 nm, and the propagation light intensity propagating through the optical fibers 21, 22 is approximately 12 dbm to 18 dbm. Both the optical fibers 21 and 22 used in the experiment are non-doped core fibers.

It is known that laser light passing through an optical fiber leaks to the outside at a connection portion or a bent portion of the optical fiber. Hereinafter, of the laser light, light radiated to the outside of the optical fibers 21, 22 is referred to as “radiation light”, and light that has passed through the optical fibers 21, 22 without being scattered and is emitted from an end portion of the optical fiber 22 is referred to as “propagation light”. In this experiment, the emission light Lout corresponds to the propagation light.

The photodiode 33 is provided at a position capable of receiving the radiation light Ls with respect to the optical fibers 21, 22, and receives the radiation light Ls. The intensity of the received radiation light Ls is converted into a radiation signal Ss and output from the photodiode 33. The photodiode 34 is provided at a position capable of receiving the propagation light emitted from the optical fiber 22, and receives the propagation light. The intensity of the received propagation light is converted into a propagation signal St and output from the photodiode 34.

In this experiment, a heat shrinkable tube 25 is provided on the surface of the fused portion M as a scattering member having a larger scattering coefficient than a scattering coefficient of the surfaces of the optical fibers 21, 22. The heat shrinkable tube 25 is transparent to laser light, but has a larger scattering coefficient than larger scattering coefficients of the optical fibers 21, 22 due to its material, surface roughness, and the shape of surface irregularities. Although the fused portion M is located inside the heat shrinkable tube 25, the heat shrinkable tube 25 is indicated by a broken line in FIG. 1, and the fused portion M is clearly shown in FIG. 1. The radiation light Ls radiated from the optical fibers 21, 22 is scattered on the surface of the heat shrinkable tube 25 and is easily received by the photodiode 33.

The control unit 3 receives the radiation signal Ss and the propagation signal St. Then, the control unit 3 compares the radiation signal Ss with the propagation signal St input at the timing coincident with the input timing of the radiation signal Ss.

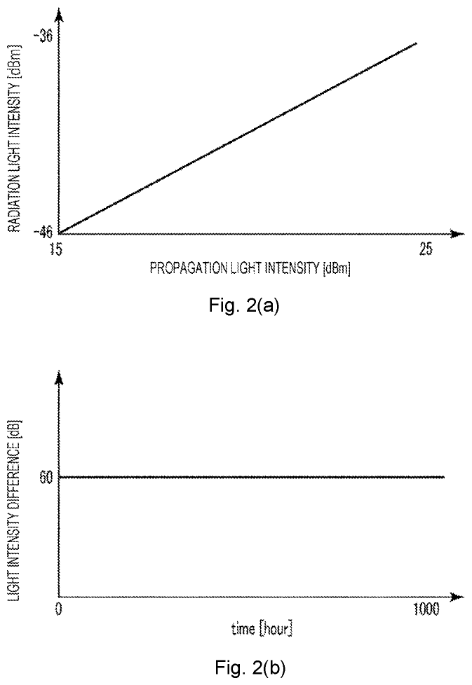

FIGS. 2A and 2B are graphs for explaining a comparison result between the radiation signal Ss and the propagation signal St with the same input timing to the control unit 3. In FIG. 2(a), the horizontal axis represents the propagation light intensity, and the vertical axis represents the radiation light intensity. The propagation light intensity is a value determined by the signal intensity (dbm) of the propagation signal St, and the radiation light intensity is a value determined by the signal intensity (dbm) of the radiation signal Ss. In FIG. 2(b), the horizontal axis represents time (hour), and the vertical axis represents a difference (db) between the propagation light intensity and the radiation light intensity.

As illustrated in FIG. 2(a), the radiation light intensity and the propagation light intensity are in a direct proportional relationship, and both exhibit preferable linearity. As illustrated in FIG. 2(b), the difference between the radiation light intensity and the propagation light intensity is substantially constant over 1000 hours or more (42 days or more). Such experimental results show that there is a strong correlation between the propagation light and the radiation light, and the correlation is stable over a long period of time. The present inventors have conceived of obtaining a relationship between a propagation light intensity and a radiation light intensity in advance for one optical system, and observing the intensity of the propagation light on the basis of the intensity of the radiation light of the optical fiber. Observation of propagation light using radiation light can reduce an error of an observation value as compared with observation using light split using a fiber coupler, regardless of photodarkening that occurs when visible light having a relatively short wavelength is incident on an optical fiber. In addition, since the optical module 1 can be downsized as compared with a bulk component such as a beam splitter, it is also suitable for downsizing an optical device.

Next, a first embodiment and a second embodiment of the present invention will be described. The drawings of the first embodiment and the second embodiment described later are intended to describe the technical idea, configuration, function, effect, and the like of the present invention, and do not limit the specific configuration of the embodiment. The drawings of the first embodiment and the second embodiment are schematic views, and the aspect ratio and the thickness are not necessarily accurately indicated. In the first embodiment and the second embodiment, the same members among the illustrated members are denoted by the same reference numerals. Configurations denoted by the same reference numerals may be partially omitted in the following description.

### First Embodiment

### (Optical Module)

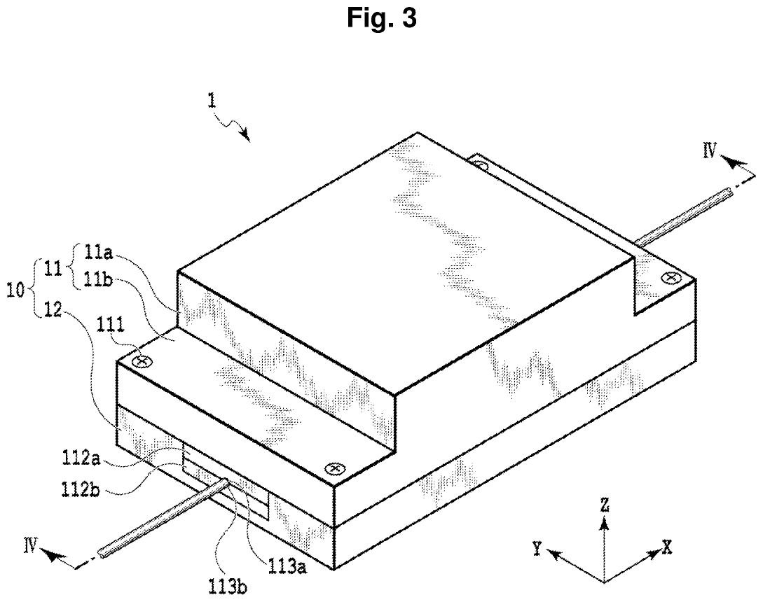

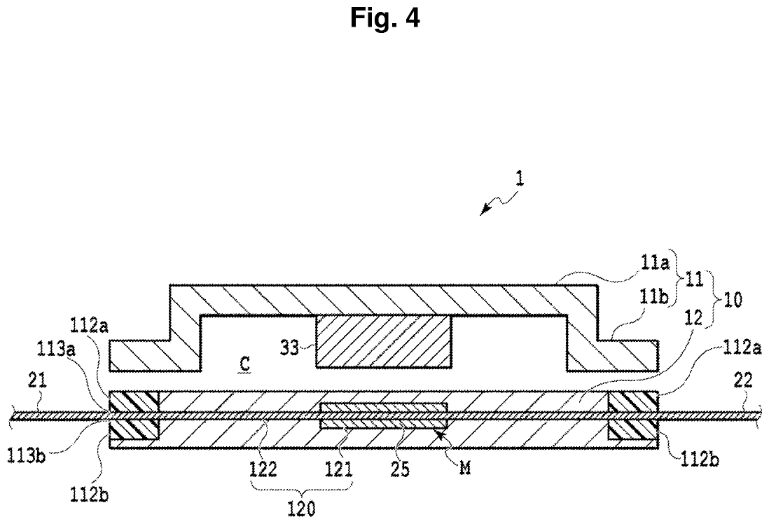

FIG. 3 is a perspective view illustrating an appearance of the optical module 1 of the first embodiment. FIG. 4 is a schematic cross-sectional view of the optical module 1 illustrated in FIG. 3 taken along the z-x plane of the coordinate system illustrated in FIG. 3. FIG. 4 is a longitudinal sectional view of the optical module 1 cut at a position bisecting the length of the optical module 1 in the y direction. In the first embodiment, the vertical direction is determined along the z-axis of the coordinate system, and a side having a relatively large z coordinate is defined as an upper side and a side having a small z coordinate is defined as a lower side.

The optical module 1 is a module provided on an optical fiber connected to an optical component capable of inputting or outputting light. Here, the optical component refers to a component to which light can be input or output, and may be a component having an optical waveguide or a light source that outputs light. The shape of the optical component having the optical waveguide is not limited, and may be, for example, an optical fiber, a sheet-like or a plate-like PLC. In addition to the optical waveguide, the optical component may incorporate a structure for branching and coupling the optical waveguide, or an electrical element, or may be a component of a bulk optical system such as a lens or a prism.

As illustrated in FIGS. 3 and 4, the optical module 1 includes: a case body 10 that forms a closed space C in which a part of optical fibers 21, 22 is accommodated; a fiber fixing portion 120 (121, 122) that fixes the optical fiber to predetermined position and shape inside the case body 10; and a photodiode 33 that is a light receiving element attached inside the case body 10 at a position capable of receiving radiation light radiated from the optical fiber fixed to the fiber fixing portion 120. The optical fibers 21, 22 may be non-doped core fibers or may be optical fibers into which rare earth is injected.

Also in the first embodiment, the optical fibers 21 and 22 are connected to each other by fusion. In the first embodiment, the photodiode 33 observes radiation light radiated from the fused portion M of the optical fibers 21, 22. However, fusion is a widely used method for connecting optical fibers, and a connection loss in the fused portion M is small. In the first embodiment, light leaking from the fused portion M is efficiently received, and the intensity of light propagating through the optical fiber is monitored with a simple configuration and low loss as compared with the case of using a fiber coupler or a beam splitter. Although FIG. 4 illustrates the configuration in which the photodiode 33 receives the radiation light Ls from above the fused portion M, the photodiode 33 is not limited to being provided above the fused portion M, and may be provided at any position as long as the position can receive the radiation light Ls having sufficient intensity for observation.

In the optical fibers 21, 22, the heat shrinkable tube 25 covers at least a radiation portion from which radiation light is radiated, and functions as a scattering member having a scattering coefficient of light larger than a scattering coefficient of the radiation portion. In the example illustrated in FIG. 4, the heat shrinkable tube 25 covers a portion including the fused portion M to protect the fused portion. The radiation portion of the radiation light is the surface of the fused portion M, and the scattering coefficient of the heat shrinkable tube 25 is larger than a scattering coefficient of the surface of the fused portion due to the composition and surface roughness of the material and the shape of irregularities of the surface. By providing the heat shrinkable tube 25, the degree of scattering of the radiation light of the optical fibers 21, 22 increases, and the light is easily received by the photodiode 33. According to such a configuration, the signal intensity of the radiation signal Ss output from the photodiode 33 can be increased, and the measurement accuracy of the radiation light can be increased.

The case body 10 includes an upper case portion 11 and a lower case portion 12, and is configured such that the upper case portion 11 and the lower case portion 12 overlap and are screwed by a screw 111. Packing portions 112a, 112b of rubber members, for example, are provided in the lower case portion 12 with the optical fibers 21, 22 interposed therebetween, and cutout portions 113a, 113b having semicircular cross sections are formed in the packing portions 112a, 112b, respectively, in order to pass the optical fibers 21, 22. The upper case portion 11 has a base portion 11b having a small length (hereinafter, referred to as “height”) in the z-axis direction and a convex portion 11a having a height higher than that of the base portion 11b, and the base portion 11b comes into contact with the packing portion 112a. The material of the case body 10 is preferably a material that does not transmit light from the outside, and for example, metal or an opaque resin is preferable. When the case body 10 is made of metal, the degree of scattering of light in the closed space C can be increased, and the light intensity of radiation light received by the photodiode 33 can be increased.

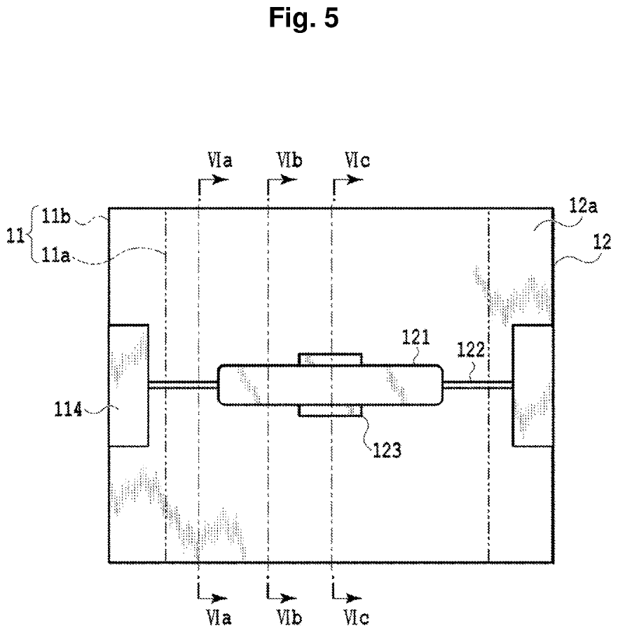

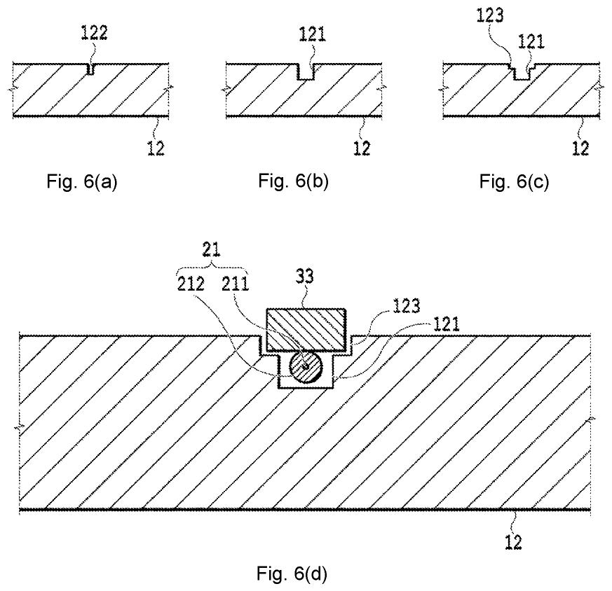

FIG. 5 is a schematic top view of the optical module 1 illustrated in FIGS. 3 and 4 as viewed from above. In FIG. 5, the upper case portion 11 is illustrated outside the lower case portion 12 by an imaginary line of a two-dot chain line in order to avoid overlapping with the lower case portion 12. FIGS. 6(a), 6(b), and 6(c) are cross-sectional views illustrating cross-sections of the lower case portion 12 taken along cross-sectional lines VIa, VIb, and VIc in FIG. 5, respectively. FIG. 6(a) is a view of a cross section along a cross-sectional line VIa as viewed in a direction of an arrow, FIG. 6(b) is a view of a cross section along a cross-sectional line VIb as viewed in a direction of an arrow, and FIG. 6(c) is a view of a cross section along a cross-sectional line VIc as viewed in a direction of an arrow. FIG. 6(d) is a diagram illustrating a positional relationship between the cross section illustrated in FIG. 6(c) and the optical fiber 21 and the photodiode 33.

As illustrated in FIGS. 5, 6(a), and 6(b), the fiber fixing portion 120 formed on the upper surface 12a of the lower case portion 12 includes a fused portion fixing portion 121 having a shape along the heat shrinkable tube 25 that covers the fused portion M of the optical fibers 21, 22, and a non-fused portion fixing portion 122 having a shape along a portion of the optical fibers 21, 22 that is not covered with the heat shrinkable tube 25. Both the fused portion fixing portion 121 and the non-fused portion fixing portion 122 are groove-shaped recesses formed on the upper surface 12a, the heat shrinkable tube 25 is fitted to the fused portion fixing portion 121, and the optical fibers 21, 22 are fitted to the non-fused portion fixing portion 122. The non-fused portion fixing portion 122 illustrated in FIG. 6(a) has the shortest length (width) in the y-axis direction illustrated in FIG. 3 in the fiber fixing portion 120, and the fused portion fixing portion 121 illustrated in FIG. 6(b) has a width larger than those of the optical fibers 21, 22 by the thickness of the heat shrinkable tube 25. The lengths (depths) in the −z-axis direction with respect to the upper surface 12a of the fused portion fixing portion 121 and the non-fused portion fixing portion 122 are constant. The fused portion fixing portion 121 and the non-fused portion fixing portion 122 fix the optical fibers 21, 22 in a state of being connected to each other in a certain position and shape.

In order to reliably fix the heat shrinkable tube 25 to the fused portion fixing portion 121, for example, an adhesive may be placed in advance on the bottom surface of the fused portion fixing portion 121, and the optical fibers 21, 22 covered with the heat shrinkable tube 25 may be placed on the adhesive with the fused portion fixing portion 121. For example, the wall surface along the length direction of the fused portion fixing portion 121, which is a recessed portion, may be inclined so as to approach upward from the bottom surface. As described above, the heat shrinkable tube 25 fitted in the fused portion fixing portion 121 is less likely to come off upward, and the reliability of measurement of the radiation light of the optical fibers 21, 22 can be enhanced. The non-fused portion fixing portion 122 is formed to have a width approximately equal to the diameter of the optical fibers 21, 22 in order to prevent the upper surfaces 12a of the optical fibers 21, 22 from being flexed or bent. The optical fibers 21, 22 are sandwiched between the packing portions 112a and 112b under the base portion 11b. For example, the packing portions 112a, 112b, which are rubber members, generate a relatively large frictional force between each other, and the reliability of fixing the optical fibers 21, 22 can be further enhanced. With the above configuration, the optical fibers 21, 22 are fixed without being bent inside the case body 10.

The lower case portion 12 includes an element fixing portion 123 further above the fused portion fixing portion 121 formed on the upper surface 12a. The element fixing portion 123 is a recess along the shape of the photodiode 33. As illustrated in FIG. 6(d), the photodiode 33 is partially fitted and fixed to the element fixing portion 123 at the time of receiving radiation light. According to such a configuration, since both the photodiode 33 and the heat shrinkable tube 25 can be fixed at the time of receiving radiation light, radiation light emitted from a certain portion of the optical fibers 21, 22 can be always received at a certain position. In addition, since the photodiode 33 can be brought close to the optical fibers 21, 22 and the heat shrinkable tube 25, the intensity of radiation light received by the photodiode 33 can be further increased.

### Optical Measurement Method

The optical measurement method performed using the optical module 1 of the first embodiment described above is an optical measurement method used to observe light propagating through the optical fibers 21, 22 connected to an optical component. The optical measurement method according to the first embodiment includes: a step of receiving radiation light radiated from optical fibers 21, 22 fixed to predetermined position and shape inside a case body 10 forming a closed space C; and a step of deciding intensity of the light propagating through the optical fibers 21, 22 on the basis of intensity of the radiation light Ls that has been received. In such an optical measurement method, since the propagated light is observed using the radiation light reflecting the propagation light, even when visible light having a relatively short wavelength is observed, the optical measurement method is not affected by the photodarkening, and a highly reliable observation result can be obtained.

### Alignment System

Next, an alignment system using the optical module 1 described above will be described.

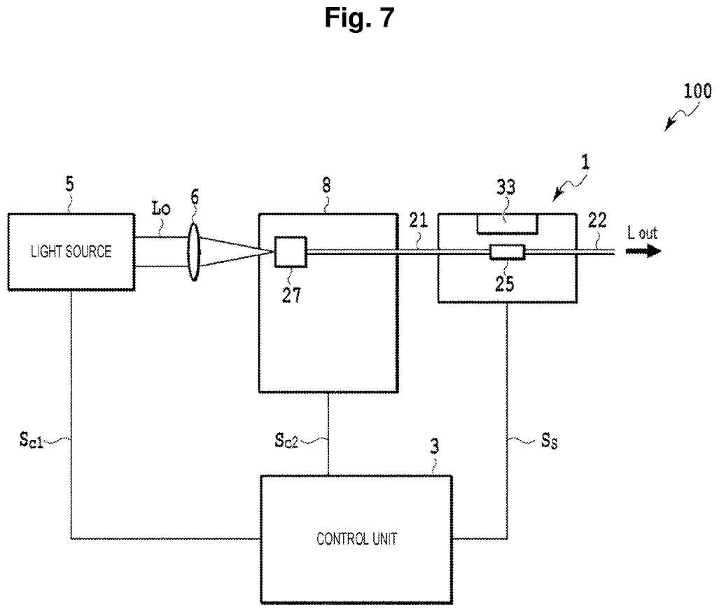

FIG. 7 is a schematic diagram for explaining an alignment system 100. The alignment system 100 is an alignment system that aligns the optical fibers 21, 22 connected to the optical component. The alignment system 100 includes the optical module 1 described above, a light source 5 that allows light to enter at least a portion of the optical fiber 21 accommodated inside the case body from one end portion (hereinafter, also referred to as an “incident end portion”) 27 of the optical fiber 21, and an alignment mechanism 8 that adjusts the position of at least one of the light source 5 and the incident end portion 27 on the basis of the radiation light received by the photodiode 33. The light source 5 is, for example, a laser light source, and a condenser lens 6 is provided between the light source 5 and the incident end portion 27. The laser light Lo emitted from the light source 5 is condensed by the condenser lens 6 and enters the incident end portion 27. The incident end portion 27 is formed by, for example, end-capping the end portion of the optical fiber 21 facing the light source 5.

The alignment system 100 illustrated in FIG. 7 adjusts an optical axis of a device including, for example, the light source 5, the condenser lens 6, the optical module 1, and an optical component (not illustrated) connected to the optical fiber 22 extending from the optical module 1. As such a device, for example, a measurement device that three-dimensionally measures an object can be considered.

The alignment system 100 includes a control unit 3 connected to the optical module 1, the alignment mechanism 8, and the light source. The control unit 3 controls a fixing position of the light source 5 and a fixing position of the incident end portion 27. The fixing position of the light source 5 can be changed by, for example, attaching the light source 5 to a drive shaft (not illustrated) and causing the control unit 3 to output a control signal Sc1 to the drive shaft to drive the drive shaft. The fixing position of the incident end portion 27 can be changed, for example, by the control unit 3 outputting a control signal Sc2 to the alignment mechanism 8 and driving a fixing table (not illustrated) to which the incident end portion 27 is fixed. At this time, the control unit 3 inputs the radiation signal Ss from the optical module 1, and specifies the positions of the light source 5 and the incident end portion 27 where the light intensity indicated by the radiation signal Ss is the strongest. Then, the control unit 3 outputs the control signal Sc1 so as to fix the light source 5 at the specified position and the control signal Sc2 to the alignment mechanism 8 so as to fix the incident end portion 27.

As described above, the alignment system 100 is not limited to the configuration in which the positions of both the light source 5 and the incident end portion 27 are adjusted, and one may be fixed and the other may be adjusted. The control unit 3 may be a dedicated device that performs the above control, or may cause a general-purpose computer to execute the above control program. The control unit 3 includes a known central processing unit (CPU), a memory device, an interface used for input and output of information, and the like in order to control the light source 5 and the alignment mechanism 8 and further decide the intensity of the radiation signal Ss.

The alignment system 100 described above can compensate for the axial deviation caused by expansion and contraction of the member due to the fluctuation in the environmental temperature and vibration, and can stabilize the ratio (optical coupling rate) of the laser light emitted from the light source 5 taken into the optical fiber 21 over a long period of time. Since the alignment system 100 can make the optical coupling rate constant even in the case of using visible light having a relatively short wavelength, the optical fiber 21 can be easily replaced without fixing the light source 5 and the optical fiber 21 with an adhesive. It is known that an end surface of an optical fiber is deteriorated particularly by use for visible light having a short wavelength. Therefore, the alignment system of the first embodiment in which the optical fiber 21 is easily replaced is particularly suitable for alignment of a device using visible light having a short wavelength.

### Second Embodiment

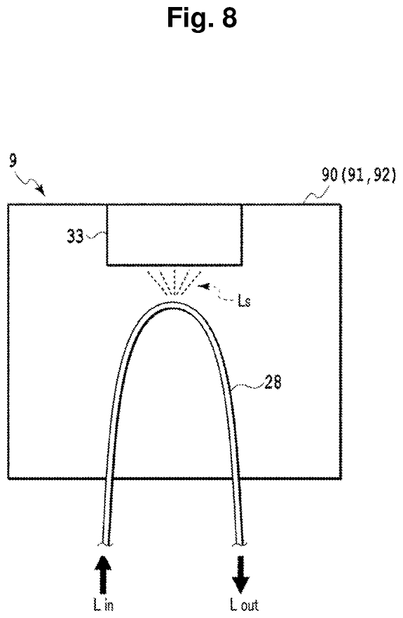

FIG. 8 is a diagram for explaining an overview of a second embodiment of the present invention. In an optical module 9 of the second embodiment, at least a part of an optical fiber 28 is inserted into a case body 90 in a bent state, and incident light Lin is incident from one end portion extending to the outside of the case body 90 and emission light Lout is emitted from the other end portion. Then, radiation light Ls radiated from the bent portion of the optical fiber 28 is received by a photodiode 33. Such a configuration can increase the light intensity of the radiation light Ls and increase the measurement accuracy of the radiation light Ls. That is, it is known that the amount of light leaking (lost) from the core changes when the optical fiber is bent, and the amount of loss increases as the bending radius increases. In the second embodiment, the radiation light Ls is observed by bending the optical fiber 28 to such an extent that the amount of light leaking from the core of the optical fiber 28 increases and the amount of loss does not become a problem.

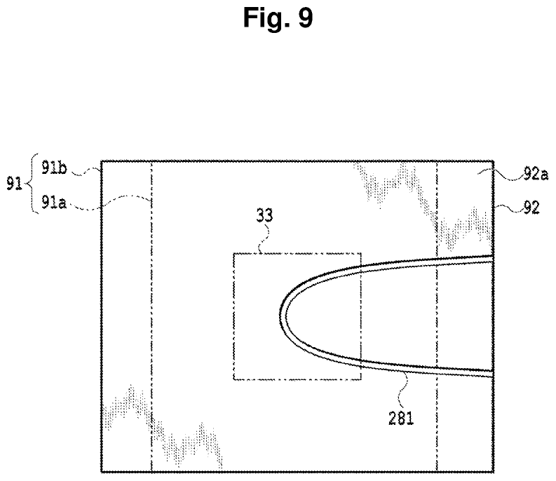

FIG. 9 is a diagram for explaining a configuration for achieving the above configuration, and is a schematic top view of the optical module 9 as viewed from above. The case body 90 of the optical module 9 is configured by combining an upper case portion 91 and a lower case portion 92. In FIG. 9, the upper case portion 91 is illustrated outside the lower case portion 92 by an imaginary line of a two-dot chain line in order to avoid overlapping with the lower case portion 92.

The lower case portion 92 includes a fiber fixing portion 281 on an upper surface 92a. The fiber fixing portion 281 includes a groove for fixing the optical fiber 28 in a bent state. The groove width of the fiber fixing portion 281 is designed to be about the same length as the diameter of the optical fiber 28 in order to prevent the optical fiber 28 from being flexed or detached. The optical fiber 28 is fitted into the groove of the fiber fixing portion 281 and is fixed in a state of curving along the shape of the fiber fixing portion 281. At this time, the optical fiber 28 may be fitted into the fiber fixing portion 281 and temporarily fixed, and the optical fiber 28 may be reliably fixed with a thermosetting resin or the like after confirming that the photodiode 33 can receive radiation light having sufficient light intensity.

It is known that the optical loss of the optical fiber 28 changes depending on the degree of bending of the optical fiber, that is, the bending radius. In the second embodiment, the optical fiber 28 is bent and fixed within a range in which the optical loss is larger than in a state without bending, propagation of light is not hindered, and mechanical damage does not occur. As such a range, for example, it is conceivable to determine the range on the basis of the short term bend radius described in the specification table of the optical fiber. At this time, it is conceivable to set the bending radius of the optical fiber 28 to 2 cm or less. The fiber fixing portion 281 is formed on the upper surface 92a as a groove having a curve matching the bending radius set in this manner.

As described above, in the second embodiment, the amount of radiation light leaking from the optical fiber 28 can be increased by bending, and the measurement accuracy of the radiation light can be enhanced. In the second embodiment, the fiber fixing portion 281 is formed on the upper surface 92a of the lower case portion 92 to fix the optical fiber at a constant bending radius. Therefore, the light amount and the radiation position of the radiation light radiated from the optical fiber are fixed, and the radiation light can be stably received by the photodiode 33. Also in the second embodiment, as similar to the first embodiment, a recess into which a part of the photodiode 33 is fitted may be provided together with the fiber fixing portion 281, and the photodiode 33 may also be fixed. As a result, the second embodiment can further stabilize the state of radiation and reception of radiation light.

### REFERENCE SIGNS LIST

1, 9 Optical module
3 Control unit
5 Light source
6 Condenser lens
8 Alignment mechanism
10, 90 Case body
11, 91 Upper case portion
12, 92 Lower case portion
12a, 92a Upper surface
21, 22, 28 Optical fiber
25 Heat shrinkable tube
27 Incident end portion
33, 34 Photodiode
100 Alignment system
120 Fiber fixing portion
121 Fused portion fixing portion
122 Non-fused portion fixing portion
123 Element fixing portion
Lout Emission light
Ls Radiation light
M Fused portion

1. An optical module provided in an optical fiber connected to an optical component capable of inputting or outputting light, the optical module comprising:
a case body that forms a closed space in which a part of the optical fiber is accommodated;
a fiber fixing portion that fixes the optical fiber to predetermined position and shape inside the case body; and
a light receiving element that is attached inside the case body at a position capable of receiving radiation light radiated from the optical fiber fixed to the fiber fixing portion.

2. The optical module according to claim 1, wherein the fiber fixing portion fixes at least two of the optical fiber connected to each other.

3. The optical module according to claim 1, wherein the fiber fixing portion fixes the optical fiber in a bent state.

4. The optical module according to claim 3, wherein a bending radius of the optical fiber fixed to the fiber fixing portion is 2 cm or less.

5. The optical module according to claim 1, further comprising a scattering member that covers at least a radiation portion from which the radiation light is emitted in the optical fiber and has a larger scattering coefficient of light than a scattering coefficient of light of the radiation portion.

6. An alignment system that aligns an optical fiber connected to an optical component capable of inputting or outputting light, the alignment system comprising:
an optical module including a case body that forms a closed space in which a part of the optical fiber is accommodated, a fiber fixing portion that fixes the optical fiber to predetermined position and shape inside the case body, and a light receiving element that is attached inside the case body at a position capable of receiving radiation light radiated from the optical fiber fixed to the fiber fixing portion;
a light source that causes light to be incident on at least a portion accommodated inside the case body of the optical fiber from one end portion of the optical fiber; and
an alignment mechanism that adjusts a position of at least one of the light source and the end portion on the basis of the radiation light received by the light receiving element.

7. The alignment system according to claim 6, wherein the light source causes light to be incident on the optical fiber at a wavelength of 150 nm or more and 700 nm or less.

8. An optical measurement method used for observing light propagating through an optical fiber connected to an optical component capable of inputting or outputting light, the optical measurement method comprising:
a step of receiving radiation light radiated from an optical fiber fixed to predetermined position and shape inside a case body forming a closed space; and
a step of determining intensity of the light propagating through the optical fiber on the basis of intensity of the radiation light that has been received.

9. The optical module according to claim 2, further comprising a scattering member that covers at least a radiation portion from which the radiation light is emitted in the optical fiber and has a larger scattering coefficient of light than a scattering coefficient of light of the radiation portion.

10. The optical module according to claim 3, further comprising a scattering member that covers at least a radiation portion from which the radiation light is emitted in the optical fiber and has a larger scattering coefficient of light than a scattering coefficient of light of the radiation portion.

11. The optical module according to claim 4, further comprising a scattering member that covers at least a radiation portion from which the radiation light is emitted in the optical fiber and has a larger scattering coefficient of light than a scattering coefficient of light of the radiation portion.
